(19) United States
(12) Patent Application Publication
(10) Pub. No.: US 2013/0050766 A1
(43) Pub. Date: Feb. 28, 2013

(54) IMAGE QUALITY CRITICAL WORKFLOW

(71) Applicants: Barry Ayash, Webster, NY (US); Joseph Harrison, Ontario, NY (US); Jack Hirsh, Ontario, NY (US)

(72) Inventors: Barry Ayash, Webster, NY (US); Joseph Harrison, Ontario, NY (US); Jack Hirsh, Ontario, NY (US)

(73) Assignee: Xerox Corporation, Norwalk, CT (US)

(21) Appl. No.: 13/216,366

(22) Filed: Aug. 24, 2011

(51) Int. Cl. G06T 5/00

(52) U.S. Cl. 358/3.26

(57) ABSTRACT

Methods and systems for maintaining image quality are disclosed. A printing system and method is provided for maintaining image quality, comprising: initially establishing a plurality of image quality threshold standards; assigning an image quality threshold standard from the plurality of image quality threshold standards to an associated image critical job; comparing the assigned image quality threshold standard of each associated image critical job to a quality system check value; and, releasing and printing selected image critical jobs if the quality system check value is at least equal to the assigned image quality threshold standard.

### BACKGROUND

In a xerographic printing system, jobs may require critical image quality and may be printed on a system that has not been, or is not currently, printing at a good image quality state. In other words, the printing system image quality state may be less than desired for critical image quality output. The present disclosure provides a workflow that can ensure that any image critical jobs would be processed when the system was in a specific image quality state, or at least at a particular image quality threshold. This disclosure is directed to a method and system for maintaining an image quality critical output.

### BRIEF DESCRIPTION

A printing system and method is provided for maintaining image quality, comprising: initially establishing a plurality of image quality threshold standards; assigning an image quality threshold standard from the plurality of image quality threshold standards to an associated image critical job; comparing the assigned image quality threshold standard of each associated image critical job to a quality system check value; and, releasing and printing selected image critical jobs if the quality system check value is at least equal to the assigned image quality threshold standard.

The present disclosure further provides for a system and a method for maintaining image quality, comprising: initially establishing a plurality of image quality threshold standards; assigning an image quality threshold standard from the plurality of image quality threshold standards to an associated image critical job; comparing the assigned image quality threshold standard of each associated image critical job to a quality system check value; queuing any image critical jobs having an assigned image quality threshold standard greater than the quality system check value; and, holding any image critical jobs having an assigned image quality threshold standard greater than the quality system check value and then releasing the held image critical jobs once the quality system check value is at least equal to the assigned image quality threshold standard of the held image critical job.

Further in accordance with the present disclosure, a method is provided for maintaining image quality, comprising: initially establishing a plurality of image quality threshold standards; assigning an image quality threshold standard from the plurality of image quality threshold standards to an associated image critical job; comparing the assigned image quality threshold standard of each associated image critical job to a quality system check value; and, holding any image critical jobs having an assigned image quality threshold standard greater than the quality system check value and then releasing the held image critical jobs once the quality system check value is at least equal to the assigned image quality threshold standard of the held image critical job.

### BRIEF DESCRIPTION OF THE DRAWINGS

The following is a brief description of the drawing used to illustrate the present disclosure, and thus, is being presented for illustrative purposes only and should not be limitative of the scope of the present disclosure, wherein:

FIG. 1 shows a flowchart illustrating a workflow for maintaining image quality critical output.

### DETAILED DESCRIPTION

In many areas of copier/printer/scanner image quality, it is desirable to establish and maintain a certain quality of output. In this manner, the workflow can be monitored and maintained at predetermined image quality levels. The workflow can include, and also ensure, that any image critical jobs are sent to a specific queue that would only release jobs if the system was in a specific image quality state. This in turn could ensure that the jobs printed would be at, or above, the specific acceptable image quality predetermined or set by the operator.

One embodiment of the method for ensuring image quality critical workflow is to describe a workflow to print image quality output. At a queue level, there can be a selection, i.e. a system check, and a corresponding quality system check value (SCV). If the system check is selected, then jobs would only be released if the system had passed system check and the resulting value was greater than or equal to the SCV entered (if a SVC was entered). The aforementioned queue would be created for critical image quality jobs. The jobs would not be released nor printed if the system is not in the specified image quality state. The aforementioned method would increase customer satisfaction when image quality is critical or a main concern. This would also improve production results and decrease consumables such as toner, paper, carrier etc., by eliminating printing of jobs when the system is not within the specified quality range. Printing when the quality range is outside the specified range wastes machine time and consumables and also decreases customer satisfaction with the overall perceived quality of the printer.

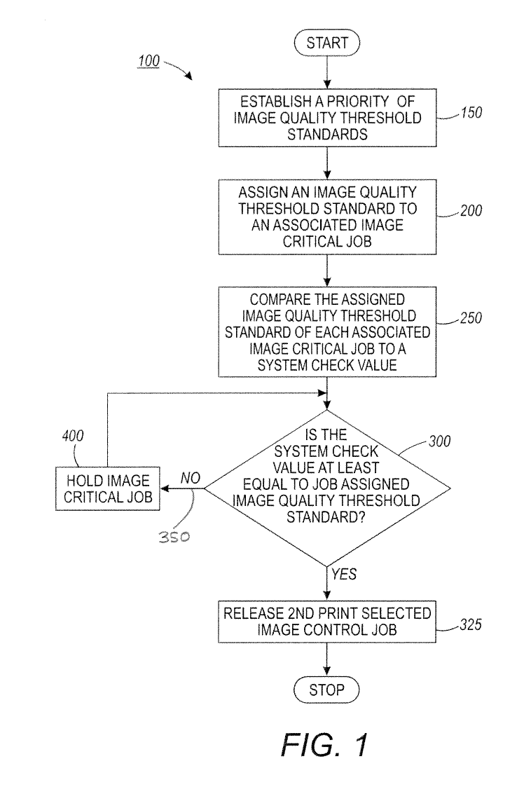

Referring to FIG. 1, the present disclosure concerns and affects image critical jobs to be printed on a system that may not be printing or outputting in a good image quality state. The disclosure seeks to take advantage of a printer's inline image quality measurement system, for example, a color maintenance tool on an iGen system. The described workflow would provide for a job queue that would release jobs if the system image quality met an operator specified threshold (predetermined quality threshold). This in turn would ensure that the jobs printed will be at the specified acceptable image quality level set by the operator. One aspect claimed is to establish queues with system image quality threshold as a queue attribute. The benefit it provides is a mechanism for customers with jobs having varying image quality expectations to control the image quality of the output. One of the results of the aforementioned method is that it allows a simple mechanism to prioritize the printing of jobs. If the system is printing in a suboptimal state, the system could hold the jobs with high image quality expectation, and release for printing the jobs with lower image quality expectations.

Referring again to FIG. 1, in one exemplary arrangement, the present disclosure provides a method for maintaining image quality 100. The method comprises initially establishing a plurality of image quality threshold standards for a print job 150. The method then assigns an image quality threshold standard from the plurality of image quality threshold standards to an associated image critical job 200. The method compares the assigned image quality threshold standard of each associated image critical job to a quality system check value 250; and, releases and prints the selected image critical jobs 325 if the quality system check value is at least equal to the assigned image quality threshold standard 300. The system can queue any image critical jobs having an assigned image quality threshold standard greater than the quality system check value 350. The system can also hold any image critical jobs 400 having an assigned image quality threshold standard greater than the quality system check value 350 and then release the held image critical jobs 325 once the quality system check value is at least equal to the assigned image quality threshold standard of the held image critical job 300. It is to be appreciated that the quality system check value can be an inline image quality measurement. And the inline image quality measurement can be a color maintenance tool (CMT). In addition, the established plurality of image quality threshold standards can be predeterminable by an operator.

In another exemplary arrangement, the present disclosure provides a method for maintaining image quality, comprising initially establishing a plurality of image quality threshold standards 150; and, assigning an image quality threshold standard from the plurality of image quality threshold standards to an associated image critical job 200. The method compares the assigned image quality threshold standard of each associated image critical job to a quality system check value 250; queues any image critical jobs having an assigned image quality threshold standard greater than the quality system check value 350; and, holds any image critical jobs 400 having an assigned image quality threshold standard greater than the quality system check value 350 and then releases the held image critical jobs 325 once the quality system check value is at least equal to the assigned image quality threshold standard of the held image critical job 300. The method further comprises releasing and printing selected image critical jobs if the quality system check value is at least equal to the assigned image quality threshold standard 325.

In still a further exemplary arrangement, the present disclosure provides a method for maintaining image quality 100, comprising: initially establishing a plurality of image quality threshold standards 150; assigning an image quality threshold standard from the plurality of image quality threshold standards to an associated image critical job 200; comparing the assigned image quality threshold standard of each associated image critical job to a quality system check value 250; and, holding any image critical jobs 400 having an assigned image quality threshold standard greater than the quality system check value 350 and then releasing the held image critical jobs 325 once the quality system check value is at least equal to the assigned image quality threshold standard of the held image critical job 300. The method additionally can queue any image critical jobs having an assigned image quality threshold standard greater than the quality system check value 350.

In one embodiment, the inline image quality measurement can be a color maintenance tool (CMT). The CMT can be initiated as a function of time or via ‘x’ number of prints, i.e. time dependent variable or volume dependent variable, respectively. For example, the system check could be initiated every thousand sheets, ten thousand sheets, every six hours, etc. Then once the system is running and processing jobs, at the predetermined initiation of the dependent variable or ‘trigger’, the system can run the CMT. If the CMT value drops below the established threshold for the queue, the job will stop running and be held until the CMT value rises above the established threshold. Once the CMT value rises to the established threshold, printing resumes for the associated print job.

Based on the methods and systems described above, the operator can select a ‘system check’ mode and a corresponding quality system check value. When the ‘system check’ mode is selected, jobs would only be released if the system output or system performance has passed system check and the resulting value was greater than or equal to the quality system check value entered into the system (if a system check value was entered). The method described improves performance of printing products and customer satisfaction of said same printing products. From an operator standpoint, the system check eliminates or decreases the number of print jobs that do not meet customer specifications, thereby reducing the number of discarded print jobs and the associated waste in consumables.

While the disclosure has been described in conjunction with the specific embodiments described above, it is evident that many alternatives, modifications and variations are apparent to those skilled in the art. Accordingly, the embodiments of the disclosure as set forth above are intended to be illustrative and not limiting. Various changes can be made without departing from the spirit and scope of the disclosure.

1. A method for maintaining image quality, comprising:
initially establishing a plurality of image quality threshold standards;
assigning an image quality threshold standard from the plurality of image quality threshold standards to an associated image critical job;
comparing the assigned image quality threshold standard of each associated image critical job to a quality system check value; and,
releasing and printing selected image critical jobs if the quality system check value is at least equal to the assigned image quality threshold standard.

2. The method of claim 1 further comprising;
queuing any image critical jobs having an assigned image quality threshold standard greater than the quality system check value.

3. The method of claim 2 further comprising;
holding any image critical jobs having an assigned image quality threshold standard greater than the quality system check value and then releasing the held image critical jobs once the quality system check value is at least equal to the assigned image quality threshold standard of the held image critical job.

4. The method of claim 1, wherein the quality system check value is an inline image quality measurement.

5. The method of claim 4, wherein the inline image quality measurement is a color maintenance tool.

6. The method of claim 5, wherein the established plurality of image quality threshold standards are predeterminable by an operator.

7. A method for maintaining image quality, comprising:
initially establishing a plurality of image quality threshold standards;
assigning an image quality threshold standard from the plurality of image quality threshold standards to an associated image critical job;
comparing the assigned image quality threshold standard of each associated image critical job to a quality system check value;
queuing any image critical jobs having an assigned image quality threshold standard greater than the quality system check value; and,
holding any image critical jobs having an assigned image quality threshold standard greater than the quality system check value and then releasing the held image critical jobs once the quality system check value is at least equal to the assigned image quality threshold standard of the held image critical job.

8. The method of claim 7 further comprising;
releasing and printing selected image critical jobs if the quality system check value is at least equal to the assigned image quality threshold standard.

9. The method of claim 8, wherein the quality system check value is an inline image quality measurement.

10. The method of claim 9, wherein the inline image quality measurement is a color maintenance tool.

11. The method of claim 10, wherein the established plurality of image quality threshold standards are predeterminable by an operator.

12. A method for maintaining image quality, comprising:
initially establishing a plurality of image quality threshold standards;
assigning an image quality threshold standard from the plurality of image quality threshold standards to an associated image critical job;
comparing the assigned image quality threshold standard of each associated image critical job to a quality system check value; and,
holding any image critical jobs having an assigned image quality threshold standard greater than the quality system check value and then releasing the held image critical jobs once the quality system check value is at least equal to the assigned image quality threshold standard of the held image critical job.

13. The method of claim 12 further comprising;
queuing any image critical jobs having an assigned image quality threshold standard greater than the quality system check value.

14. The method of claim 12 further comprising;
releasing and printing selected image critical jobs if the quality system check value is at least equal to the assigned image quality threshold standard.

15. The method of claim 12, wherein the quality system check value is an inline image quality measurement.

16. The method of claim 15, wherein the inline image quality measurement is a color maintenance tool.

17. The method of claim 12, wherein the established plurality of image quality threshold standards are predeterminable by an operator.
